(19) United States
(12) Patent Application Publication
(10) Pub. No.: US 2016/0273060 A1
(43) Pub. Date: Sep. 22, 2016

(54) BACTERIAL STRAIN, CUTIPAY, ISOLATED FROM THE SULFOBACILLUS THERMOSULFIDOOXIDANS SPECIES, BACTERIAL INOCULUM COMPRISING SAME, AND METHOD FOR THE BIOLEACHING OF MINERALS WHERE SAID BACTERIAL INOCULUM IS INOCULATED

(71) Applicant: BIOSIGMA S.A., Santiago (CL)

(72) Inventors: Roberto Andrés BOBADILLA FAZZINI, Las Condes, Santiago (CL); Pilar PARADA VALDECANTOS, Ñuñoa, Santiago (CL)

(21) Appl. No.: 15/034,449

(22) PCT Filed: Nov. 20, 2013
(86) PCT No.: PCT/IB2013/060286

§ 371 Date: May 4, 2016

(51) Int. Cl. C12R 1/01; C22B 3/18

(52) U.S. Cl. CPC C12R 1/01; C22B 3/18

(57) ABSTRACT

The invention relates to a bacterial strain isolated from the species Sulfobacillus thermosulfidooxidans, named Cutipay, deposited in the DSMZ (under the denomination DSM 27601 on July the 29^{th}, 2013); This strain is useful in mining bioleaching processes, as it is highly resistant to the toxic element chloride ion. The invention also relates to a bacterial inoculum to be used in the leaching of metal sulfide ores or metal concentrates, comprising Sulfobacillus thermosulfidooxidans DSM 27601 strain Cutipay; and a method for bioleaching of ores where an ore is provided, which is selected from a metal sulfide ore or metal concentrate. Said ore is subsequently inoculated with the bacterial inoculum of the invention, and maintained at a pH of between 1 and 4, and at a temperature of between 10 and 60° C.

### TECHNICAL FIELD

The present invention focuses on the technical field of mining by hydrometallurgical processes in a wide range of temperature, ambient (10 to 45° C.) and predominantly above ambient (above 45° C.). In particular, the present invention relates to moderate thermophilic acidophilic microorganisms (optimal growth above 45° C. and below 60° C.) and the use thereof in processes for obtaining metals from low grade sulfide minerals and/or copper sulfide concentrates through bio-hydrometallurgical processes, in tanks or stirred reactors, vats, heaps, dumps and/or tailing dams.

### BACKGROUND

Currently, over 90% of world copper mining is obtained from the processing of copper sulfide ores. Among the mineral species of copper sulfide present, the main ones are chalcopyrite, bornite, chalcocite, covellite, tennantite and enargite, being chalcopyrite the most abundant species, and therefore the one with major economic interest.

The processing of copper sulfide ores today is based on physical and chemical processes associated with crushing, grinding and flotation of ores, followed by fusion-conversion of the concentrates and electrolytic metal refining (electrowining). In practice, over 80% of the copper is produced by ore processing through the described route—called conventional—which is limited to minerals of high and middle grades, depending on the specific characteristics of the deposits and ore processing plants. It is for this reason that there are vast and valuable mineral resources with relatively low grades that with conventional technologies are non-economically viable, and remain unexplored due to the lack of an effective technology.

It has been long established that the leaching of sulfide ores is favored by the presence of iron (II) and sulfur oxidizing bacteria, see for example the review of Rawlings D E (Biomineralization of metal-containing ores and Concentrates; TRENDS in Biotechnology, Vol. 21, No. 1, pp. 38-42, 2003). In the extraction of these sulfide ores, such as the secondary sulfides covellite (CuS) and chalcocite (Cu₂S), satisfactory copper recovery rates and extraction of approximately 85% recovery at 270 days of operation are obtained in bioleaching heaps or dumps at commercial scale, using mesophilic microorganisms, i.e. those having optimum growth temperatures in the range of 25-45° C., such as Acidithiobacillus spp. and Leptospirillum spp.

However, for the case of chalcopyrite mineral (CuFeS₂) that, as indicated, is the most abundant copper ore, mesophilic microorganisms normally used in bioleaching show a very low leach rate, so that in industrial operations the copper recovered associated to the chalcopyrite fraction is considered negligible.

On the other hand, many evolutionary processes have allowed the development of life at high temperatures. Thermophilic microorganisms are characterized to optimally live and reproduce at temperatures that are above 45° C. These microorganisms, including bacteria and archaea, can also be acidophilic and develop on bioleaching processes including species of genera such as Acidimicrobium, Sulfobacillus, Acidianus, Sulfolobus and Metallosphaera, among others. Thus, there are bioleaching processes for chalcopyrite concentrates at high temperature so as to achieve higher degrees of dissolution and leaching rates than those obtained with mesophilic microorganisms. Rorke & Batty, 2006

However, an important element that interferes with the operation of acidophilic microorganisms in general is the increase of chloride ion concentration in bioleaching processes. Chloride is an abundant element in mining processes, particularly in those with water shortage, where it is associated with the solutions recirculation in the presence of copper oxidized species such as atacamite. To date very few acidophilic halotolerant microorganisms have been found, i.e. able to tolerate high salt concentrations and in particularly chloride, who also have fast kinetics of iron (II) oxidation and/or sulfides, so that they can be useful in bio-hydrometallurgical processes. In this regard, it has been reported that the specific presence of chloride ion inhibits iron (II) oxidation in biomining microorganisms (Gahan et. al. 2010) and that the adaptation of these microbial cultures to higher concentrations of chloride ion is very restricted (Shiers et. al., 2005)

Beyond the presence of salts in mining operations, the present invention allows to solve the problem of low copper recovery in minerals such as chalcopyrite since it increases copper recovery in 60.7% in processes with high concentrations of chloride ion, opening the use of sea water or water with high concentrations of salt, in industrial processes for which the use of fresh or pre-treated water was previously required.

More particularly, the advantage of the invention is based on the fact that the inoculation of Sulfobacillus thermosulfidooxidans strain Cutipay increases in up to 73.7% the copper recovery from primary sulfides (mainly chalcopyrite) in the presence of high concentrations of chloride ion.

### PRIOR ART

The present invention is referred to the acidophilic bacteria Sulfobacillus thermosulfidooxidans strain Cutipay, and its use in metal recovery processes from low grade sulfide ores via bio-hydrometallurgical processes, particularly in heaps and dumps, so as to increase copper recovery from primary copper sulfides, together with its greater resistance to toxic elements corresponding to chloride ions, with respect to a reference strain of the same specie.

Some related documents are summarized herein.

The international patent application 10,201,095 US201 A1 “Method of Treating a Sulfide Mineral” requested by BHP Billiton in 2009, describes a process comprising the bioleaching of copper sulfides containing chalcopyrite with a solution of chloride ion between 1.5 and 30 g/L, and a mixed culture of Leptosprillium ferriphilum and a halotolerant or halophilic sulfur oxidizing microorganism, but does not refer to species or strains of the genus Sulfobacillus.

The international patent application WO2010012030A “Process for Controlled Homogeneous Acid Leaching”, requested by BHP Billiton in 2009, describes a leaching solution to leach aimed metals. It indicates that the solution is determined empirically, given the characteristics of the ores to be leached. In particular, it is mentioned that the solution contains, among others, Thiobacillus thiooxidans, T. ferrooxidans, Leptospirillum sp., Sulfobacillus thermosulfidooxidans, Sulfolobus brierleyl, S. acidocaldarius, Sulfolobus BC, S. solfataricus, S. metallicus, Thiomicrospora sp., Achromatium sp., Macromonas sp., Thiobacterium sp., Thiospora sp., Thiovulum sp., Acidithiobacillus, Acidimicrobium, Ferrimicrobium acidiphilum, Alicyclobacillus, Acidianus, Metallosphaera, Thermoplasma and mixtures thereof. This document mentions the halotolerant microorganism Thiobacillus prosperus sp. nov., but makes no reference to such characteristic for species or strains of the genus Sulfobacillus.

In the scientific publication of Xia et al. (“Investigation of the sulfur speciation During chalcopyrite leaching by moderate thermophile Sulfobacillus thermosulfidooxidans”, International Journal of Mineral Processing, 94, 1-2, 52-57, Feb. 19 2010) the study of a particular strain of Sulfobacillus thermosulfidooxidans and its application is described in leaching operations, however, no reference nor indication that the strain is resistant to high concentrations of chloride ion is given.

As previously mentioned, in the prior art several documents indicating the use of a set of bacteria and/or the exclusive use of acidophilic Sulfobacillus thermosulfidooxidans bacteria for the bioleaching of copper and other metals from primary sulfides are described, but none refers to its resistance to the toxic element chloride ion.

### BRIEF DESCRIPTION OF THE FIGURES

FIG. 1. Recovery of Cu (II) in bioleaching assays with chalcopyrite concentrate and 3 g chloride ion/L, incubation at 50° C. and addition of Sulfobacillus thermosulfidooxidans DSM 27601 strain Cutipay (▴); Sulfobacillus acidophilus DSM 10332 (♦); Control without inoculation (▪).

### BRIEF DESCRIPTION OF THE INVENTION

The invention discloses a mixohetrotrophic bacterial strain able to oxidize Fe(II) ion under aerobic conditions with optimal growth at 45° C. and pH 2.0-2.5 and further having a minimum inhibitory concentration of up to 10 g chloride/L, which implies a resistance between 3.3 and 5 times higher compared to the collection strain Sulfobacillus acidophilus DSM 10332.

The invention also considers the bacterial inoculum comprising the above-described strain and the bioleaching process for copper sulfide ores in the presence of high concentrations of chloride ion using the bacterium Sulfobacillus thermosulfidooxidans strain Cutipay.

### DETAILED DESCRIPTION OF THE INVENTION

For greater understanding of the processes the following terms are referred:

a) Ore bioleaching vats: process performed in a pond with false bottom where the loaded ore is flooded with leaching solution which is circulated through the ore particles, in the presence of acidophilic microorganisms, extracting the copper dissolved in an acidic solution.

b) Ore bioleaching in tanks or stirred reactors: the bioleaching process is carried out in a mechanical stirred tank where finely grinded ore is mixed with the leach solution to form a pulp with a solid content of up to 20%, with the presence of acidophilic microorganisms, extracting the copper dissolved in an acidic solution.

c) Ore bioleaching in heaps: In this process the ore crushed to a defined grain size is piled over an impermeable surface with low slope, and the leaching solution is irrigated on the surface, in the presence of acidophilic microorganisms, extracting at the base the copper dissolved in an acidic solution.

d) Ore bioleaching in dumps: Ores beneath the cutoff grade, which are extracted from an open pit are stocked as “run of mine” or with a primary crushing, in ravines that have appropriate characteristics to control solutions infiltration or previously installed waterproof surfaces where the leaching solution is irrigated on the surface in the presence of acidophilic microorganisms, extracting at the base the copper dissolved in an acidic solution.

e) Tailings bioleaching: tailings from froth flotation process containing smaller amounts of the metal present in the ore are collected in dams, from which they are re-processed to be leached in either heaps or stirred tanks, in the presence of acidophilic microorganisms extracting the copper dissolved in an acidic solution.

f) “In situ” or “in place” bioleaching: ore deposits in their natural or fractured state due to previous mining operations, are directly leached irrigating the leaching solution through their surface, in the presence of acidophilic microorganisms, extracting at the base the copper dissolved in an acidic solution.

g) Inoculum: pure or mixed bacterial culture that will act as active biological material during bioleaching.

h) DSMZ “Deutsche Sammlung von Mlkroorganlsmen und Zellkulturen GmbH,” German Collection of Microorganisms and cell cultures.

The present invention contemplates a particular strain of Sulfobacillus thermosulfidooxidans named Cutlpay deposited at the DSMZ (Deutsche Sammlung von und Mlkroorganlsmen Zellkulturen GmbH, Braunschweig, Germany) under the code DSM 27601 on July the 29^{th}, 2013. This strain has been identified as an elemental sulfur, sulfides and iron oxidizing bacteria, Gram-positive, sporulating, acidophilic, and moderately thermophilic. Microbiological characterization show an optimum growth temperature of 45° C. and an optimum pH range between 2.0 to 2.5, when grown in the presence of Fe(II) and/or yeast extract supplemented with sulfides. This strain has a high resistance to toxic element chloride ion.

Based on phylogenetic analysis, strain Cutipay was identified as a Sulfobacillus thermosulfidooxidans species. Said strain of the present invention comprises three partial operons 5S, 16S, and 23S, in addition to differences in the arsenic resistance encoded in the operon arsRB. The arsRB operon includes arsR regulator, arsB arsenite efflux pump, kumamolisin-As precursor as well as the glycosyl transferase codifying genes. The strain also comprises the putative gene arsC in another genome region, encoding for the enzyme arsenate reductase, and that has not been previously described for S. thermosulfidooxidans strains, indicating arsenic resistance capabilities. Genome analysis shows putative copper-sensing genes copR and copS and the gene for a DNA binding transcriptional activator of copper-responsive regulon genes cueR, indicating the presence of a copAZ resistance operon.

In a particular embodiment of the invention, it is considered a bacterial inoculum to be used in the leaching of metal sulfide ores, comprising Sulfobacillus thermosulfidooxidans DSM 27601 strain Cutipay.

In another embodiment of the invention, the bacterial inoculum comprising Sulfobacillus thermosulfidooxidans DSM 27601 strain Cutipay in pure culture or in combination with microorganisms chosen from Acidithiobacillus biomineros spp., Acidithiobacillus ferrooxidans, Acidithiobacillus thiooxidans, Acidithiobacillus caldus, Acidithiobacillus ferrivorans, Acidithiobacillus albertensis, Acidithiobacillus cuprithermicus, Leptospirillum spp., Leptospirillum ferrooxidans, Leptospirillum ferriphilum, Leptospirillum ferrodiazotrophum, Leptospirillum rubarum, Ferroplasma spp., Ferroplasma acidarmanus, ferroplasma acidiphilum, Ferroplasma cupricumulans, Ferroplasma thermophilum, Sulfobacillus spp. Sulfobacillus acidophilus, Sulfobacillus benefaciens, Sulfobacillus sibiricus, Acidimicrobium spp., Acidimicrobium ferrooxidans, Alicyclobacillus spp., Alicyclobacillus acidiphilus, Alicyclobacillus acidocaldarius, Alicyclobacillus acidoterrestris, Alicyclobacillus aeris, contaminans Alicyclobacillus, Alicyclobacillus cycloheptanicus, Alicyclobacillus disulfidooxidans, Alicyclobacillus fastidiosus, Alicyclobacillus ferripilum, ferrooxydans Alicyclobacillus, Alicyclobacillus Herbarius, Alicyclobacillus hesperidum, Alicyclobacillus kakegawensis, Alicyclobacillus macrosporangiidus, Alicyclobacillus mali, Alicyclobacillus pohliae, Alicyclobacillus pomorum, Alicyclobacillus sacchari, Alicyclobacillus sendaiensis, Alicyclobacillus shizuokensis, Alicyclobacillus tengchongensis, Alicyclobacillus tolerans, Alicyclobacillus vulcanalis, Acidicaldus spp., Acidicaldus organivorans, Acidocella spp., Acidocella aluminiidurans, Acidocella aminolytica, Acidocella facilis, Ferrimicrobium spp., Ferrimicrobium acidiphilum, Ferrithrix spp., Ferrithrix thermotolerans and mixtures thereof.

In a more specific embodiment of the invention it is considered a process of leaching of ores, wherein i) an ore is provided, selected from metal sulfide ores or metal sulfide concentrates, ii) subsequently, the said mineral is inoculated with an inoculum of the present invention, and iii) a pH in the range of 1 to 4, and a temperature in the range of 10 to 60° C. are maintained.

In another embodiment of the invention, the leaching process considered a preferred pH range of 1.4 and 3.5, and a preferred temperature range between 30 to 50° C.

In a specific embodiment of the present invention, the ore to be leached in the leaching process is a metal sulfide ore.

In another specific embodiment of the invention, the metal concentrate contains chalcopyrite.

In an even more specific embodiment of the present invention, the mineral leaching process can be performed according to a leaching process in situ, in place, in vats, tanks, reactors, heaps, dumps or tailings dams.

In another embodiment the leaching of ores considered the irrigation with recycled solutions containing chloride ion concentrations above 2 g/L.

In another embodiment of the invention, in the leaching process the ore contains chloride ion concentrations above 0.01% w/w (0.1 g/L).

### EXAMPLES

### Example 1

Culture Conditions

Sulfobacillus thermosulfidooxidans DSM 27601 strain Cutipay was grown in KMD medium supplemented with 0.25 g/L yeast extract and 3 g/L Fe(II) and incubated with shaking at 50° C. and initial pH 1.6.

### Example 2

Minimum Inhibitory Concentration Assays

Minimum inhibitory concentration (MIC) assays were performed in six-well plates with 5 mL of KMD culture medium inoculated with 1×10⁷ cells/mL and incubated with shaking at 45 or 50° C. and initial pH 1.6. Different concentrations of chloride ion (as NaCl or KCl), Cu (II) (as CuSO₄) and As (III) (as As₂O₃) were assayed and assessed for growth by monitoring optical count. The concentration for which growth and/or oxidation activity was not observed corresponds to the minimum inhibitory concentration (MIC).

### Example 3

Bioleaching Assay with Addition of Sulfobacillus thermosulfidooxidans DSM 27601 Strain Cutipay in the Presence of Chloride Ion

Bioleaching assays under moderate thermophilic conditions were performed in duplicate in shake flasks. Each flask with 200 mL of minimal KMD medium (pH 1.6) supplemented with 1.5 g/L Fe(III), 2.5 g/L Fe(II) and 3 g/L chloride ion (added as NaCl) with 1% w/v of chalcopyrite concentrate (85.5% chalcopyrite, representing over 99% of Cu on each assay). The culture medium was initially inoculated with Sulfobacillus thermosulfidooxidans DSM 27601 strain Cutipay. Controls were included without inoculation or inoculated with strain collection Sulfobacillus acidophilus DSM 10332. Flasks were incubated with shaking at 50° C. and initial pH 1.6. Weekly determinations were made for cell counts, total Fe and Cu(II) by atomic absorption spectrometry (AAnalyst 400, Perkin Elmer). Concentration of Fe(II) was performed using the colorimetric method of o-phenanthroline.

TABLE 1
Minimum Inhibitory Concentration (MIC) of Toxic elements
chloride ion (potassium and sodium salts), Cu(II) and
As(III) present in Raffinate Industrial Solutions for
strain of industrial interest and collection strain.

| | Chloride | Chloride | Cu(II) | As(III) |
|---|---|---|---|---|
| Species | (KCl) [g/L] | (NaCl) [g/L] | [g/L] | [g/L] |
| Thermophilic strains | 50° C. | | | |
| Sulfobacillus | 10 | 5 | 3 | <0.1 |
| thermosulfidooxidans | | | | |
| DSM 27601 (Cutipay) | | | | |
| Sulfobacillus | 3 | 1 | 1 | 1 |
| acidophilus | | | | |
| DSM 10332 | | | | |

### Example 4

Verification of Improved Growth and Oxidizing Microbial Activity Rates for Sulfobacillus thermosulfidooxidans DSM 27601 Strain Cutipay with Improved Resistance to Chloride Ion in Chalcopyrite Bioleaching Assays

Previous studies confirmed the increased resistance of Sulfobacillus thermosulfidooxidans DSM 27601 strain Cutipay to chloride ions both at 45 as well as 50° C. compared with the collection Sulfobacillus acidophilus strain DSM 10332. From the foregoing, it is possible to conclude that strain Cutipay has particular capabilities of the use of this microorganism in bioleaching processes. To confirm this, chalcopyrite concentrate bioleaching assays were conducted in shake flasks under moderate thermophilic conditions (50° C.) inoculated with Sulfobacillus thermosulfidooxidans DSM 27601 strain Cutipay and including separately controls without inoculation or inoculated with the collection strain Sulfobacillus acidophilus DSM 10332. These assays show that under the culture conditions the addition of the strain

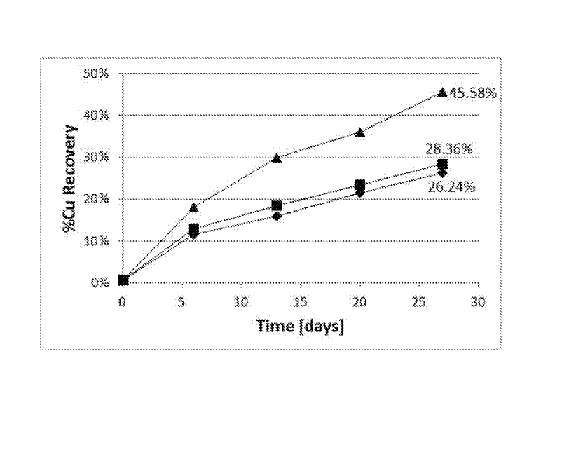

Cutipay copper recovery increases up to 73.7 and 60.7% compared to controls without inoculation and inoculated with Sulfobacillus acidophilus DSM 10332, respectively (see FIG. 1). These results demonstrate on the one hand the kinetic effect of temperature on copper recovery considering that in analogous assays without inoculation but incubated at 30° C. the average copper recovery does not exceed 10%, and on the other hand that under moderate thermophilic bioleaching processes in the presence of chloride ion (3 g/L chloride ion) the inoculation of Sulfobacillus thermosulfidooxidans DSM 27601 strain Cutipay enhances the bioleaching of chalcopyrite.

### INDUSTRIAL APPLICATION

The present invention, that consideres Sulfobacillus thermosulfidooxidans strain Cutipay and its use, has industrial application, as it can be used in bioleaching processes.

1. An isolated bacterial strain of the species Sulfobacillus thermosulfidooxidans, named Cutipay and deposited at the DSMZ (Deutsche Sammlung von Mikroorganismen and Zellkulturen GmbH, Braunschweig, Germany) under the code DSM 27601 on July the 29^{th}, 2013; wherein said strain is useful in mining bioleaching processes, it and has a high resistance to the toxic element chloride ion.

2. A bacterial inoculum for use in leaching of metal sulfide ores, wherein the bacterial inoculum comprises the Sulfobacillus thermosulfidooxidans DSM 27601 strain Cutipay according to claim 1.

3. The bacterial inoculum according to claim 2, comprising the Sulfobacillus thermosulfidooxidans DSM 27601 strain Cutipay in pure culture or in combination with biomining microorganisms selected from Acidithiobacillus spp., Acidithiobacillus ferrooxidans, Acidithiobacillus thiooxidans, Acidithiobacillus caldus, Acidithiobacillus ferrivorans, Acidithiobacillus albertensis, Acidithiobacillus cuprithermicus, Leptospirillum spp., Leptospirillum ferrooxidans, Leptospirillum ferriphilum, Leptospirillum ferrodiazotrophum, Leptospirillum rubarum, Ferroplasma spp., Ferroplasma acidarmanus, Ferroplasma acidiphilum, Ferroplasma cupricumulans, Ferroplasma thermophilum, Sulfobacillus spp. Sulfobacillus acidophilus, Sulfobacillus benefaciens, Sulfobacillus sibiricus, Acidimicrobium spp., Acidimicrobium ferrooxidans, Alicyclobacillus spp., Alicyclobacillus acidiphilus, Alicyclobacillus acidocaldarius, Alicyclobacillus acidoterrestris, Alicyclobacillus aeris, Alicyclobacillus contaminans, Alicyclobacillus cycloheptanicus, Alicyclobacillus disulfidooxidans, Alicyclobacillus fastidiosus, Alicyclobacillus ferripilum, Alicyclobacillus ferrooxydans, Alicyclobacillus Herbarius, Alicyclobacillus hesperidum, Alicyclobacillus kakegawensis, Alicyclobacillus macrosporangiidus, Alicyclobacillus mali, Alicyclobacillus pohliae, Alicyclobacillus pomorum, Alicyclobacillus sacchari, Alicyclobacillus sendaiensis, Alicyclobacillus shizuokensis, Alicyclobacillus tengchongensis, Alicyclobacillus Tolerans, Alicyclobacillus vulcanalis, Acidicaldus spp., Acidicaldus organivorans, Acidocella spp., Acidocella aluminiidurans, Acidocella aminolytica, Acidocella facilis, Ferrimicrobium spp., Ferrimicrobium acidiphilum, Ferrithrix spp., Ferrithrix thermotolerans and mixtures thereof.

4. A process of ore bioleaching, wherein an ore is provided, selected from a metal sulfide ore and a metal concentrate, and wherein subsequently said ore is inoculated with the inoculum according to claim 2, and maintained at a pH in the range of 1 to 4, and at a temperature in the range of 10 to 60° C.

5. A process of ore bioleaching, wherein an ore is provided, selected from a metal sulfide ore and a metal concentrate, and wherein subsequently said ore is inoculated with the inoculum according to claim 3, and maintained at a pH in the range of 1 to 4, and at a temperature in the range of 10 to 60° C.

6. A process of ore bioleaching according to claim 4, wherein the pH is maintained between 1.4 and 3.5, and the temperature is maintained in the range of 30 to 50° C.

7. A process of ore bioleaching according to claim 4, wherein the metal sulfide ore or metal concentrate contains chalcopyrite.

8. A process of ore bioleaching according to claim 4, wherein the ore is leached in situ, in place, in vats, tanks, reactors, heaps, dumps or tailings dams.

9. A process of ore bioleaching according to claim 4, wherein the ore is irrigated with recycling solutions containing chloride ion concentrations above 2 g/L.

10. A process of ore bioleaching according to claim 4, wherein the ore contains chloride ion concentrations above 0.01% w/w.
